(19) United States
(12) Patent Application Publication
(10) Pub. No.: US 2026/0302257 A1
(43) Pub. Date: Oct. 1, 2026

(54) Method for Generating a Porous Conductor and Lithium Ion Battery

(71) Applicant: BAYERISCHE MOTOREN WERKE AKTIENGESELLSCHAFT, Muenchen (DE)

(72) Inventors: Bjoern-Ingo Hieronymus HOGG, Muenchen (DE); Thomas WOEHRLE, Muenchen (DE)

(21) Appl. No.: 19/489,923

(22) PCT Filed: May 28, 2024
(86) PCT No.: PCT/DE2024/100485

§ 371 Date: Dec. 4, 2025

(30) Foreign Application Priority Data
Jun. 5, 2023 (DE) 10 2023 114 688.2

(51) Int. Cl. H01M 4/66; C01B 32/05; H01M 4/02; H01M 4/04; H01M 10/0525

(52) U.S. Cl. CPC H01M 4/663; C01B 32/05; H01M 4/0447; H01M 10/0525; C01P 2002/02; C01P 2006/40; H01M 2004/027

(57) ABSTRACT

A method for generating a porous conductor for an electrode of a lithium ion battery includes: a) providing a porous conductor precursor, wherein the conductor precursor comprises polytetrafluoroethylene, and b) at least partly converting the polytetrafluoroethylene present in the porous conductor precursor into amorphous carbon by exposure to metallic lithium, thereby forming the porous conductor. The invention also relates to a lithium ion battery.

### BACKGROUND AND SUMMARY

The invention relates to a process for producing a porous conductor for an electrode of a lithium ion battery, and to a lithium ion battery comprising an electrode with a porous conductor.

The term “lithium ion battery” is used synonymously hereinafter for all terms for lithium-containing galvanic elements and cells that are commonly used in the art, for example lithium battery, lithium cell, lithium ion cell, lithium ion battery, lithium-polymer cell and lithium ion accumulator. In particular, rechargeable batteries (secondary batteries) are included. The terms “battery,” “cell” and “electrochemical cell” are also used synonymously with the term “lithium ion battery.” The lithium ion battery may also be a solid-state battery, for example a ceramic or polymer-based solid-state battery.

Lithium ion batteries have at least two different electrodes: a positive electrode (cathode) and a negative electrode (anode). Each of these electrodes has at least one active material, each of which is applied to a conductor for electrical contacting. The cathode and the anode are arranged one on top of another during the production process to form an electrode arrangement, for example in stacks, in which case a separator is used between cathode and anode for electrical insulation.

In lithium ion batteries, both the anode and the cathode must be capable of accepting and releasing lithium ions. Of particular interest are lithium ion batteries that use metallic lithium (also referred to hereinafter as “lithium metal”) as anode active material, since these have a particularly high specific capacity. This results in a high energy density or specific energy of the lithium ion battery, which can also be referred to in this case as lithium-metal cell.

A challenge associated with the use of such lithium metal anodes is that of achieving maximum homogeneity of deposition of metallic lithium in the course of charging and simultaneously using a maximum current density in order to shorten the charging time. Especially in the case of use in at least partly electrically operated vehicles, a minimum charging time is of crucial importance. Inhomogeneous deposition of lithium promotes the formation of what are called “lithium dendrites” proceeding from the lithium metal anode, which can lead to damage to the separator and hence to internal short circuits. Lithium dendrites can also react in a kinetically rapid manner with the electrolyte system of the lithium ion battery, which irreversibly reduces cell capacity.

A further problem associated with the use of lithium metal anodes is occurrence of changes in volume as a result of the lithium metal being deposited and dissolved, which can cause an increase or reduction in cell volume by about 10% to 20%. This “breathing” of the electrodes of the lithium ion battery necessitates complex design configurations in every charge/discharge cycle in order to reduce the resulting mechanical stress. Otherwise, the result may be different pressure distribution at the cell level over the assembly of electrodes and separators, mechanical damage such as pulverization, cracking, reduction of porosity, especially of porosity of the separator, pore closure, pore clogging or uncoupling of the electrode film from the conductor, which can have an adverse effect on lifetime, performance and reliability of the lithium ion battery.

A known approach to reducing the changes in volume of the lithium ion battery is at least partial use of porous conductors, such that lithium metal can be deposited in the porosity that exists. For this purpose, conventional rolled metal foils may be provided with openings or perforations, for example perforated foils, or it is possible to make use of what are known as expanded metals as conductors. Also known is the use of metallized glass-weave foils, as described, for example, in EP 3 740 981 A1. However, such conductors are costly by virtue of their respective production process.

It is an object of the disclosure to provide a conductor that enables defined lithium deposition and is suitable for use in lithium ion batteries. It is also an object of the disclosure to provide a lithium ion battery with long lifetime and/or high specific energy, especially at reduced cost.

The object of the disclosure is achieved by a process for producing a porous conductor for an electrode of a lithium ion battery, comprising the following steps: a) a porous conductor precursor is provided, where the conductor precursor comprises polytetrafluoroethylene, and b) the polytetrafluoroethylene present in the porous conductor precursor is at least partly reacted with metallic lithium to give amorphous carbon to form the porous conductor.

The term “conductor” here and hereinafter refers to what is known as a “current conductor.”

It is known that polytetrafluoroethylene (PTFE), on contact with metallic lithium, can be converted to amorphous carbon compounds with formation of lithium fluoride (LiF). For example, Guobao Li et al.: “The influence of polytetrafluorethylene reduction on the capacity loss of the carbon anode for lithium ion batteries” (Solid State Ionics, vol. 90 (1 -4), pp. 221-225, 2019, doi: 10.1016/S0167-2738(96)00367-0) states that PTFE used as binder in an electrode of a lithium ion battery makes an irreversible contribution to loss of formation of the lithium ion battery, since the lithium present in the lithium ion battery is partly consumed by reaction with PTFE to form lithium fluoride (LiF). This effect is additionally described in Zhang et al.: “Revisiting Polytetrafluorethylene Binder for Solvent-Free Lithium-Ion Battery Anode Fabrication” (Batteries, vol. 8 (6), p. 57, 2022, doi: 10.3390/batteries 8060057) and Jansta et al.: “Low temperature electrochemical preparation of carbon with a high surface area from polytetrafluoroethylene” (Carbon, vol. 13 (5), pp. 377-380, doi: 10.1016/0008-6223(75)90005-6).

The disclosure is based on the basic concept of producing a porous conductor with defined three-dimensional structure by specifically chemically converting a conductor precursor that contains PTFE and has a defined porous structure by contact with metallic lithium. In this way, a porous conductor is produced, the porosity of which derives from the porosity of the particular conductor precursor used. The resulting porous structure of the conductor ensures that, when the porous conductor is used in a lithium ion battery, metallic lithium can be deposited in a defined and homogeneous manner on the porous conductor, such that the formation of lithium dendrites during charging and discharging operations is effectively suppressed or at least reduced. At the same time, changes in volume that occur are minimized, since the metallic lithium can at least partly accumulate within the pore structure of the porous conductor as it forms.

It has been found that, surprisingly, amorphous carbons obtained from PTFE by reaction with metallic lithium have sufficient mechanical stability to be used as conductor in an electrode for lithium ion batteries. At the same time, amorphous carbons have sufficiently high electrical conductivity to be able to handle the currents to be expected in lithium ion batteries.

A further advantage of the porous conductor based on an amorphous carbon that has been produced is that electrodes having such a porous conductor have high flexibility and low weight, especially by comparison with conventional conductors based on rolled metal foils, for example rolled aluminum foils.

In one variant, the porous conductor precursor is a fabric, a nonwoven, a stretched foil, a punched foil or a membrane. Corresponding fabrics, nonwovens and membranes consisting of PTFE or comprising PTFE are commercially available globally. Moreover, fabrics, nonwovens and membranes provide a defined porous three-dimensional structure which is at least partly conserved, preferably essentially completely conserved, even after reaction of the PTFE with metallic lithium.

Accordingly, the porosity and shape of the porous conductor can be defined by the choice of a suitable conductor precursor. It is thus fundamentally possible to implement any desired configuration of the porous conductor.

The porous conductor precursor may consist of polytetrafluoroethylene. In this way, a porous conductor consisting solely of amorphous carbon and optionally the further reaction productions formed in the reaction of PTFE with metallic lithium, especially lithium fluoride and/or unconverted PTFE, is producible.

In an alternative embodiment, the porous conductor precursor may comprise an electrically conductive matrix coated with polytetrafluoroethylene. Thus, the reaction of the PTFE on the surface of the electrically conductive matrix produces amorphous carbon, which contributes to electrical conductivity of the porous conductor formed.

The porosity of the conductor precursor may be provided by the applied coating with PTFE and/or by the electrically conductive matrix, and so the porosity of the porous conductor produced is also provided by the amorphous carbon and/or by the electrically conductive matrix.

The matrix may comprise a metal or a metal alloy. For example, the matrix is formed from copper, nickel and/or steel.

In order to provide even higher electrical conductivity, it is possible in step b) to convert at least 90 mole percent of the polytetrafluoroethylene present in the porous conductor precursor, preferably at least 95 mole percent. More preferably, the polytetrafluoroethylene present in the porous conductor precursor is fully converted.

What is meant by the expression “fully converted” in this context is that the PTFE present is fully chemically converted, apart from unavoidable losses.

In one alternative, the metallic lithium is applied to the porous conductor precursor in step b).

For example, the porous conductor precursor is provided with metallic lithium via a gas phase method such as chemical gas phase deposition (CVD) or physical gas phase deposition (PVD).

It is also possible that the conductor precursor is coated with liquefied lithium. It is also possible to press non-liquefied lithium mechanically into the conductor precursor.

Prior to contacting with metallic lithium, the conductor precursor may be moistened with an electrolyte, especially with the same electrolyte which is to be used in the later use of the porous conductor produced in a lithium ion battery.

For example, the electrolyte comprises an electrolyte solvent that preferably contains an organic solvent selected from the group consisting of ethylene carbonate (EC), propylene carbonate (PC), butylene carbonate, dimethyl carbonate (DMC), diethyl carbonate (DEC), ethyl methyl carbonate (EMC), fluoroethylene carbonate (FEC), sulfolane, 2-methyltetrahydrofuran, acetonitrile, 1,3-dioxolane, γ-butyrolactone (GBL) and combinations thereof.

In a further alternative, the porous conductor precursor, before step b), is assembled to a lithium ion battery with a lithium-containing counterelectrode and a separator disposed between the porous conductor precursor and the counterelectrode, wherein step b) is effected during a charging and discharging operation of the lithium ion battery. In this way, the porous conductor of the lithium ion battery is produced in situ.

It will be apparent that, in this configuration, the porous conductor precursor must already have sufficient electrical conductivity to serve as conductor during the charging and discharging operation of the lithium ion battery in which the porous conductor precursor is converted to the porous conductor.

The porous conductor precursor may be assembled to an electrode with further components known for applications in lithium ion batteries, for example a binder or electrode binder, and the electrode is then combined with the counterelectrode and the separator to form the lithium ion battery.

In an alternative variant, the electrode consists of the porous conductor precursor.

The lithium-containing counterelectrode is especially a cathode comprising any pre-or overlithiated cathode active material capable of providing the desired amount of lithium for conversion of the PTFE.

The overlithiated cathode active material may contain a lithium-containing additive that breaks down to release lithium ions in the first charging operation of the lithium ion battery. For example, the lithium-containing additive comprises or is lithium peroxide (Li2O2).

Moreover, the cathode active material may be pre-or overlithiated such that, even after conversion of the PTFE in the porous conductor precursor, an amount of lithium cyclable within the lithium ion battery that enables a desired capacity of lithium ion battery for the intended use of the lithium ion battery is provided. For example, the cathode active material may be what is called an “overlithiated oxide” (OLO).

It is also possible that the cathode active material is selected such that it releases more lithium ions in the first charging operation of the lithium ion battery than are incorporated back into the structure of the cathode active material in the immediately subsequent discharging structure (also referred to as “irreversible loss” or “first cycle efficiency”). In this way, the loss of lithium ions available for cycling that occurs in any case can be utilized for conversion of the conductor precursor to the porous conductor. Illustrative cathode active materials of this kind are described in Hu et al.: “Revisiting the initial irreversible capacity loss of LiNi0.6Co0.2Mn0.2O2 cathode material batteries” (Energy Storage Materials, vol. 50, 2022, pp. 373-379, doi: 10.1016/j.ensm.2022.05.038) and Kang et al.: “Investigating the first-cycle irreversibility of lithium metal oxide cathodes for Li batteries” (J Mater Sci, vol. 43, pp. 4701-4706, doi: 10.1007/s10853-007-2355-6).

The porous conductor is accordingly intended and set up in particular for use in an anode of a lithium ion battery, preferably a lithium metal anode.

Fundamentally, however, it is also possible that the porous conductor, especially if not first produced in an already assembled lithium ion battery, is used as conductor in a cathode of a lithium ion battery.

The object of the disclosure is also achieved by a lithium ion battery comprising an electrode with a porous conductor, wherein the porous conductor has been obtained by a process as described above.

The features and properties of the process of the disclosure are correspondingly applicable to a lithium ion battery of the disclosure, and vice versa.

The lithium ion battery of the disclosure, by virtue of the porous conductor produced by the process of the disclosure, is notable for merely small changes in volume during charging and discharging operations, for example changes in volume of below 5%, preferably of below 1%, based in each case on the total volume of the lithium ion battery. In this way, the lithium ion battery has a long lifetime and high dimensional stability.

Moreover, the lithium ion battery, with the same content of active materials, has a higher specific energy density compared to lithium ion batteries that use purely metal-based conductors, for example conductors made of rolled foil.

The porous conductor preferably has a three-dimensional pore structure. The three-dimensional pore structure assures homogeneous three-dimensional deposition of metallic lithium during the charging operation of the lithium ion battery.

The three-dimensional pore structure is defined in accordance with the disclosure by the arrangement and type of structural elements present in the porous conductor. For example, the three-dimensional pore structure is defined via lands of the porous conductor, especially via the land width, land thickness, land length and crossing points of the lands.

In particular, the three-dimensional pore structure is defined by the porous conductor precursor used in the production of the lithium ion battery.

The porous conductor is preferably the conductor an anode of the lithium ion battery, more preferably of a lithium metal anode.

Further advantages and properties of the invention will be apparent from the description of illustrative embodiments that follows, which should not be interpreted in a restrictive manner, and the drawings. These show:

### BRIEF DESCRIPTION OF THE DRAWINGS

FIG. 1: a schematic of a conductor precursor as usable in a process of the disclosure for production of a porous conductor,

FIG. 2: a schematic of a conductor that has been obtained by reacting the conductor precursor with metallic lithium,

FIG. 3: a schematic sectional view through a lithium ion battery in which the conductor precursor from FIG. 1 is installed, and

FIG. 4: a lithium ion battery of the disclosure.

### DETAILED DESCRIPTION OF THE DRAWINGS

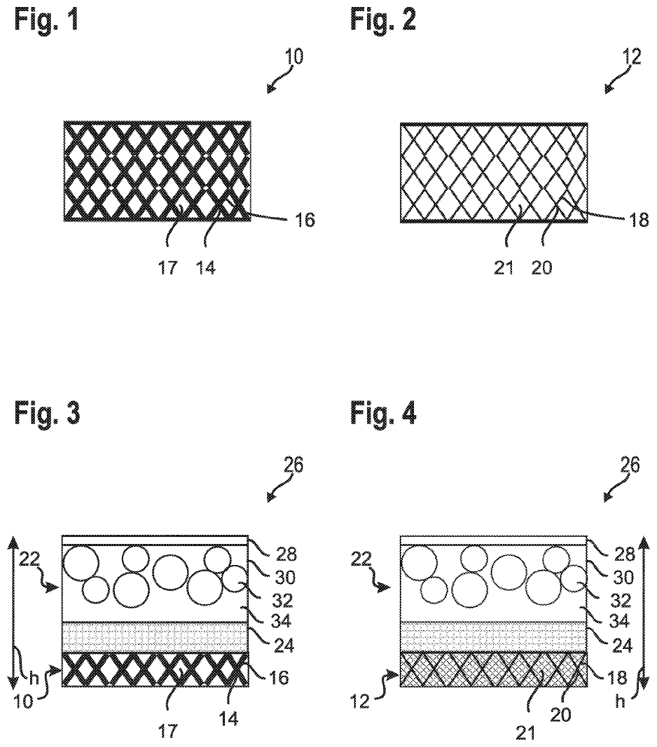

FIG. 1 shows a schematic of a porous conductor precursor 10 which is used in a process of the disclosure for production of a porous conductor 12 (cf. FIG. 2).

The conductor precursor 10 is a porous fabric made of polytetrafluoroethylene (PTFE) that has a multitude of lands 16 connected via crossing points 14. There are pores 17 between the crossing points 14 and lands 16 that determine the porosity of the conductor precursor 10. Corresponding PTFE fabrics as starting material are commercially available globally.

It will be apparent that the structure of the porous fabric in FIG. 1 is indicated merely by way of example. All that is crucial is that the conductor precursor 10 has a defined porosity. It is also possible for the conductor precursor 10 to be a porous nonwoven or a porous membrane, for example, rather than a porous fabric.

In the schematic diagram of FIG. 1, the conductor precursor 10 has an essentially symmetrical pore structure. Of course, alternative configurations are also possible, in which there is an irregular and three-dimensional pore structure in the conductor precursor 10.

According to the disclosure, the PTFE present in the conductor precursor 10 is reacted with metallic lithium to form amorphous carbon, forming the porous conductor 12 (cf. FIG. 2).

In particular, at least 90 mole percent of the PTFE present in the porous conductor precursor 10 is converted.

The porous conductor 12 likewise has a porous structure essentially corresponding to that of the conductor precursor 10, especially with regard to land widths and thicknesses, the open geometry and the open areas. In other words, the choice of the porous conductor precursor 10 used simultaneously determines the structure and geometry of the porous conductor 12. Accordingly, the porous conductor 12 in the embodiment shown has conductor lands 18 connected via conductor crossing points 20 to form a three-dimensional and porous network having conductor pores 21.

The porous conductor 12 is intrinsically mechanically stable and flexible. Moreover, the porous conductor 12 is electrically conductive by virtue of the amorphous carbon formed from the PTFE.

The porous conductor precursor 10 can be converted to the porous conductor 12 by applying metallic lithium to the conductor precursor 10. For example, the porous conductor precursor is immersed into metallic lithium, or metallic lithium is applied to the porous conductor precursor 10 by a CVD or PVD process.

The reaction between the PTFE of the porous conductor precursor 10 and the metallic lithium applied sets in immediately and can be controlled via the amount of metallic lithium applied and/or the contact time thereof on the porous conductor precursor 10.

Once the porous conductor 12 has been obtained, it can be installed in an electrode for a lithium ion battery, and it can be used in a lithium ion battery. It is also possible that the porous conductor 12 alone forms the electrode of the lithium ion battery.

In principle, it is also possible that the porous conductor precursor 10 does not consist of PTFE but comprises an electrically conductive matrix coated with PTFE. All that is crucial is that the PTFE of the porous conductor precursor 10 is at least partly accessible to metallic lithium.

FIGS. 3 and 4 show an alternative embodiment of the process of the disclosure.

In this embodiment, the porous conductor precursor 10 is assembled to a lithium ion battery 26 with a counterelectrode 22 and a separator 24 disposed between the counterelectrode 22 and the porous conductor precursor 10.

The counterelectrode 22 is a cathode and comprises a cathode conductor 28 to which a cathode film 30 has been applied.

The cathode conductor 28 may be a nonporous rolled aluminum foil, for example a rolled aluminum foil as known from EP 3 714 078 B1.

The cathode film 30 comprises a particulate cathode active material 32 and an electrode binder 34.

The porous conductor precursor 10 forms the anode of the lithium ion battery 26, such that the lithium ion battery 26 shown is what is known as a “lithium-free” anode that does not contain cyclable lithium in the anode in the uncharged state of the lithium ion battery 26 and hence constitutes the pure anode current collector.

The cathode active material 32 is lithiated and hence capable of reversibly releasing and accepting lithium ions during a first charging and discharging operation of the lithium ion battery 26.

In this embodiment, the porous conductor precursor 10 is itself electrically conductive, in such a way that the porous conductor precursor 10 can function as conductor of the (lithium-free) anode of the lithium ion battery 26.

It is thus possible that the PTFE present in the porous conductor precursor 10 is converted during a charging and discharging operation of the lithium ion battery 26. The charging of the lithium ion battery 26 results in migration of lithium ions from the counterelectrode 22, i.e. the cathode, through the separator 24 to the porous conductor precursor 10, which may be precipitated as metallic lithium at the crossing points 14 and lands 16 within the porous structure of the conductor precursor 10. The PTFE of the porous conductor precursor 10 thus comes into contact with metallic lithium and is converted to lithium fluoride and amorphous carbon to form the porous conductor 12.

In this way, the pores of the porous conductor 12 formed in situ are filled with lithium, such that a lithium metal anode is formed (cf. FIG. 4). The porosity, given suitable choice of the amount of lithium originally present in the cathode active material 32, can essentially prevent any change in the total volume of the lithium ion battery 26, as illustrated in FIGS. 3 and 4 by the height h of the lithium ion battery 26 shown.

Subsequently, the lithium ion battery 26 with the porous conductor 12 obtained by the process of the disclosure is immediately ready for use.

Alternatively, the porous conductor 12 or the lithium-containing anode may be removed from the lithium ion battery 26 and incorporated in a new lithium ion battery.

1-10. (canceled)

11. A process for producing a porous conductor for an electrode of a lithium ion battery, the process comprising:
providing a porous conductor precursor comprising polytetrafluoroethylene, and
exposing the polytetrafluoroethylene to metallic lithium to at least partly convert the polytetrafluoroethylene to amorphous carbon, thereby forming the porous conductor.

12. The process according to claim 11, wherein the porous conductor precursor has a form of a fabric, a nonwoven, a stretched film, a punched film or a membrane.

13. The process according to claim 11, wherein the porous conductor precursor consists of the polytetrafluoroethylene.

14. The process according to claim 11, wherein the porous conductor precursor comprises an electrically conductive matrix coated with the polytetrafluoroethylene.

15. The process according to claim 11, wherein at least 90 mole percent of the polytetrafluoroethylene is converted to amorphous carbon.

16. The process according to claim 11, wherein the polytetrafluoroethylene is fully converted to amorphous carbon.

17. The process according to claim 11, wherein the exposure to metallic lithium occurs via a gas-phase method.

18. The process according to claim 17, wherein the gas-phase method comprises chemical vapor deposition (CVD) or physical vapor deposition (PVD).

19. The process according to claim 11, wherein the exposure to metallic lithium occurs via coating with liquefied lithium.

20. The process according to claim 11, wherein the exposure to metallic lithium occurs by pressing non-liquefied lithium mechanically into the conductor precursor.

21. The process according to claim 11, wherein, prior to the exposure to metallic lithium, the conductor precursor is moistened with an electrolyte.

22. The process according to claim 11, wherein, prior to the exposure to metallic lithium, the porous conductor precursor is assembled with a lithium ion battery having a lithium-containing counterelectrode and a separator disposed between the porous conductor precursor and the lithium-containing counterelectrode.

23. The process according to claim 22, wherein the exposure to metallic lithium is effected during a charging and discharging operation of the lithium ion battery.

24. A lithium ion battery comprising an electrode with the porous conductor obtained by the process according to claim 11.

25. The lithium ion battery according to claim 24, wherein the porous conductor has a three-dimensional pore structure.
